(19) United States
(12) Patent Application Publication
(10) Pub. No.: US 2021/0018802 A1
(43) Pub. Date: Jan. 21, 2021

(54) DISPLAY PANEL, DISPLAY DEVICE AND MANUFACTURING METHOD THEREOF

(71) Applicants: HEFEI XINSHENG OPTOELECTRONICS TECHNOLOGY CO., LTD., Hefei, Anhui (CN); BOE TECHNOLOGY GROUP CO., LTD., Beijing (CN)

(72) Inventors: Ruifang Du, Beijing (CN); Zijun Cao, Beijing (CN); Xiaoye Ma, Beijing (CN)

(21) Appl. No.: 16/338,300

(22) PCT Filed: Oct. 8, 2018
(86) PCT No.: PCT/CN2018/109353

§ 371 Date: Mar. 29, 2019

(30) Foreign Application Priority Data
Jan. 19, 2018 (CN) 201820092083.5

(51) Int. Cl. G02F 1/1362; H05F 3/02

(52) U.S. Cl. CPC G02F 1/136204; G02F 1/136286; H05F 3/02

(57) ABSTRACT

A display panel includes a first anti-static wiring and a second anti-static wiring which are disposed at the periphery of a display area. The second anti-static wiring is electrically connected to the first anti-static wiring via a first anti-static unit. The second anti-static wiring is disposed at the periphery of the first anti-static wiring, and the first anti-static wiring and the second anti-static wiring are both electrically connected to a circuit board of the display device.

### CROSS-REFERENCE TO RELATED APPLICATIONS

This application is based on International Application No. PCT/CN2018/109353, filed on Oct. 8, 2018, which is based upon and claims priority to Chinese Patent Application No. 201820092083.5, filed Jan. 19, 2018, the entire contents of which are incorporated herein by reference as.

### TECHNICAL FIELD

The present disclosure relates to the field of display technologies, and more particularly, to a display panel, a display device and a manufacturing method thereof.

### BACKGROUND

Internal static electricity will be inevitably generated in the production and use of a display device, the resulting static electricity will be accumulated inside the display device if it is not discharged in time, once the static electricity is accumulated to a certain extent, momentary discharge with a large current will occur, i.e., a phenomenon of ESD (Electro Static Discharge). Some components like an integrated circuit or internal wiring of the display device may burn out due to the ESD.

It should be noted that the foregoing information disclosed in Background are only for the purpose of enhancement of the understanding of the background of the present disclosure and therefore the information can include information that does not constitute the existing technology already known to those of ordinary skill in the art.

### SUMMARY

The present disclosure provides a display panel and a display device.

Other features and improvements of the present disclosure will become apparent from the following detailed descriptions, or can be partially learned by practice of the present disclosure. According to an aspect of the present disclosure, there is provided a display panel. The display panel includes a first anti-static wiring and a second anti-static wiring which are disposed at the periphery of a display area. The second anti-static wiring is electrically connected to the first anti-static wiring via a first anti-static unit.

An orthographic projection of the second anti-static wiring on a display surface of the display panel is located at the periphery of an orthographic projection of the first anti-static wiring on the display surface of the display panel, and the first anti-static wiring and the second anti-static wiring are both electrically connected to a circuit board of the display panel. In an exemplary arrangement of the present disclosure, the display panel further includes a common electrode. The second anti-static wiring is electrically connected to the common electrode via a second anti-static unit.

The common electrode is also electrically connected to the circuit board.

In an exemplary arrangement of the present disclosure, the common electrode is disposed on an entire surface in the display area.

In an exemplary arrangement of the present disclosure, the first anti-static unit and the second anti-static unit are both switching transistors. A control terminal of the first anti-static unit and a control terminal of the second anti-static unit are both connected to the second anti-static wiring.

In an exemplary arrangement of the present disclosure, a number of the first anti-static unit and the second anti-static unit is two.

In an exemplary arrangement of the present disclosure, an insulating layer is disposed between the first anti-static wiring and the second anti-static wiring.

In an exemplary arrangement of the present disclosure, the display panel further includes an array substrate and a color filter substrate disposed opposite to each other to form a cell, and an electrostatic protection layer disposed on a side of the color filter substrate facing away from the array substrate, the electrostatic protection layer being connected to a housing.

In an exemplary arrangement of the present disclosure, the second anti-static wiring is electrically connected to the electrostatic protection layer via a first silver paste, which is distributed on three sides of the display panel with no flexible circuit board being provided.

In an exemplary arrangement of the present disclosure, a metal oxide electrode is further disposed between the second anti-static wiring and the first silver paste.

In an exemplary arrangement of the present disclosure, the second anti-static wiring is electrically connected to the electrostatic protection layer via a second silver paste, which is distributed on one side of the display panel on which the flexible circuit board is provided.

In an exemplary arrangement of the present disclosure, a metal oxide electrode is further disposed between the second anti-static wiring and the second silver paste.

In an exemplary arrangement of the present disclosure, a connection point is provided on one side of the display panel, and the first anti-static wiring and the second anti-static wiring are electrically connected to the circuit board via the connection point. The first anti-static wiring and the second anti-static wiring are surrounding at the periphery of the display area on the other three sides than the one side of the display panel.

In an exemplary arrangement of the present disclosure, the first anti-static wiring and the second anti-static wiring are located in different layers of the display panel, and the insulating layer is provided across the different layers.

In an exemplary arrangement of the present disclosure, the display panel is a frameless display panel.

According to an aspect of the present disclosure, there is provided a display device, including the above display panel.

According to an aspect of the present disclosure, there is provided a method for manufacturing a display panel. The method includes preparing a substrate. The substrate includes a display area and is provided with a circuit board of the display panel. The method includes disposing a first anti-static wiring and a second anti-static wiring at the periphery of the display area. The second anti-static wiring is electrically connected to the first anti-static wiring via a first anti-static unit. An orthographic projection of the second anti-static wiring on a display surface of the display panel is located at the periphery of an orthographic projection of the first anti-static wiring on the display surface of the display panel, and the first anti-static wiring and the second anti-static wiring are both electrically connected to the circuit board.

In an exemplary arrangement of the present disclosure, the method further includes forming a common electrode on the display area. The common electrode being disposed on an entire surface in the display area. The second anti-static wiring is electrically connected to the common electrode via a second anti-static unit. The common electrode is also electrically connected to the circuit board.

In an exemplary arrangement of the present disclosure, the first anti-static unit and the second anti-static unit are both switching transistors, and a control terminal of the first anti-static unit and a control terminal of the second anti-static unit are both connected to the second anti-static wiring.

In an exemplary arrangement of the present disclosure, the method further includes disposing an insulating layer between the first anti-static wiring and the second anti-static wiring.

In an exemplary arrangement of the present disclosure, the first anti-static wiring and the second anti-static wiring are located in different layers of the display panel, and the insulating layer is formed across the different layers.

It is to be understood that both the foregoing general description and the following detailed description are exemplary and explanatory only and are not restrictive of the present disclosure, as claimed. This section provides an overview of various implementations or examples of the techniques described in present disclosure, and rather than a full disclosure of the full scope or all the features of the disclosed techniques.

### BRIEF DESCRIPTION OF THE DRAWINGS

The accompanying drawings, which are incorporated in and constitute a part of this specification, illustrate arrangements consistent with the present disclosure and, together with the description, serve to explain the principles of the present disclosure. Obviously, the following accompany drawings are merely some arrangements of the present disclosure, and one person skilled in the art may obtain other accompany drawings according to the following accompany drawings without paying any creative labor.

FIG. 1 is a flow chart schematically showing a display device having an electrostatic protection function according to an exemplary arrangement of the present disclosure;

FIG. 2 is a diagram schematically illustrating a bonding manner for a first silver paste according to an exemplary arrangement of the present disclosure;

FIG. 3 is a diagram schematically illustrating a bonding manner for a second silver paste according to an exemplary arrangement of the present disclosure;

FIG. 4 is a diagram schematically illustrating an ohmic contact layer of a second anti-static wiring according to an exemplary arrangement of the present disclosure;

FIG. 5 is a flow chart schematically showing a conventional display device having an electrostatic protection function; and

FIG. 6 is a flow chart schematically showing a method for manufacturing a display panel according to an exemplary arrangement of the present disclosure.

### DETAILED DESCRIPTION

The exemplary arrangements will now be described more fully with reference to the accompanying drawings. However, the exemplary arrangements can be implemented in various forms and should not be understood as being limited to the examples set forth herein; rather, these arrangements are provided so that this disclosure will be thorough and complete, and the conception of exemplary arrangements will be fully conveyed to those skilled in the art. The features, structures or characteristics described herein may be combined in one or more arrangements in any suitable manner. In the following description, numerous specific details are provided so as to allow a full understanding of the arrangements of the present disclosure. However, those skilled in the art will recognize that the technical solutions of the present disclosure may be practiced without one or more of the specific details, or other methods, components, devices, operations and so on may be used. In other cases, the well-known technical solutions are not shown or described in detail to avoid obscuring various aspects of the present disclosure.

In addition, the drawings are merely schematic representations of the present disclosure and are not necessarily to scale. A thicknesses and a shape of each individual layer in the drawings do not reflect true scale, but are provided only for explaining the contents of the present disclosure. The same reference resigns in the drawings denote same or similar parts, and repeated descriptions thereof will be omitted.

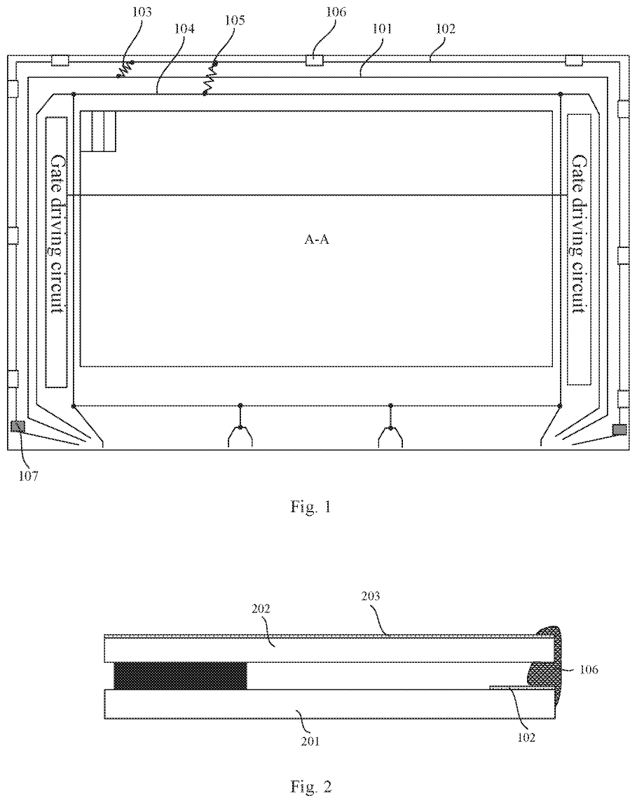

This exemplary arrangement provides a display panel having an electrostatic protection function. As shown in FIG. 1, the display panel may include a first anti-static wiring 101 and a second anti-static wiring 102 which are disposed at the periphery of a display area A-A. The second anti-static wiring 102 is located at the periphery of the first anti-static wiring 101 and is electrically connected to the first anti-static wiring 101 via a first anti-static unit 103. Moreover, the first anti-static wiring 101 and the second anti-static wiring 102 are both required to be electrically connected to a circuit board of a display device, such as a Chip on Film (COF). In this arrangement, the second anti-static wiring 102 may be arranged at the periphery of the first anti-static wiring 101 in such a manner that the second anti-static wiring 102 and the first anti-static wiring 101 are both disposed at the periphery of the display area A-A, and the second anti-static wiring 102 is further away from the display area A-A than the first anti-static wiring 101. In other words, at the same position, a distance between the second anti-static wiring 102 and the display area A-A is greater than a distance between the first anti-static wiring 101 and the display area A-A.

A connection point to a driving circuit may be provided on one side of the display panel, such as, a bottom side, and the first anti-static wiring 101 and the second anti-static wiring 102 are electrically connected to a circuit board on the one side, and are surrounding at the periphery of the display area A-A on the other three sides.

In the display panel provided by this exemplary arrangement of the present disclosure, the first anti-static wiring 101 and the second anti-static wiring 102 are both electrically connected to the circuit board, and are also connected to each other via the first anti-static unit 103. In this way, when an ESD occurs, a transient current is directed to the second anti-static wiring 102, at this time, the first anti-static unit 103 is turned on by voltage of the second anti-static wiring 102 to direct current on the second anti-static wiring 102 to the first anti-static wiring 101, and the transient current generated by ESD can be directly directed to the circuit board by the second anti-static wiring 102 on one hand, and also directed to the circuit board by the second anti-static wiring 102 via the first anti-static unit 103 and the first anti-static wiring 101 on the other hand, thus enabling electrostatic discharge, to exert an electrostatic protection effect.

Further, as illustrated in FIG. 1, the display panel may further include a common electrode 104 located inside the display area A-A. The second anti-static wiring 102 may be electrically connected to the common electrode 104 via a second anti-static unit 105. The common electrode 104 is also electrically connected to the circuit board of the display device.

In this way, when an ESD occurs, transient current can be directed to the second anti-static wiring 102, at this time, the second anti-static unit 105 is turned on by voltage of the second anti-static wiring 102 so as to direct current on the second anti-static wiring 102 to the common electrode 104, and the transient current generated by ESD can be guided to the circuit board by the second anti-static wiring 102 via the second anti-static unit 105 and the common electrode 104, to realize electrostatic discharge, therefore, the display panel is electrostatically protected. Since the common electrode 104 is generally disposed on an entire surface in the display area A-A, the common electrode 104 has a small resistance, so that quick electrostatic discharge can be achieved.

In this exemplary arrangement, an insulating layer may be disposed at a separation position between the first anti-static wiring 101 and the second anti-static wiring 102. During the long-term use of the display device, even if the outermost second anti-static wiring 102 is slightly corroded, the interior of the display panel is immune to the corrosion due to the arrangement of the insulating layer, thus display quality can be ensured.

It should be understood that, in the present disclosure, the first anti-static wiring 101 and the second anti-static wiring 102 may be located on the same layer in the display panel, or may be located on different layers as long as positional relations of projections of the first anti-static wiring 101 and the second anti-static wiring 102 on a substrate satisfy positional relations set forth in the present disclosure.

In addition, in the case where the first anti-static wiring 101 and the second anti-static wiring 102 are located on different layers, the insulating layer there between may be provided across multiple layers, thus allowing the inside of the display panel to be immune to external corrosion.

In view of above descriptions, the first anti-static unit 103 and the second anti-static unit 105 can both be turned on by the voltage of the second anti-static wiring 102 to transfer current, hence, the first anti-static unit 103 and the second anti-static unit 105 may both be a switching transistor such as a Metal Oxide Semiconductor (MOS) transistor, and a control terminal of the first anti-static unit 103 and the second anti-static unit 105 is a gate electrode of the switching transistor, which is connected to the second anti-static wiring 102. Since a transient high voltage is generated upon the electrostatic discharge, the first anti-static unit 103 and the second anti-static unit 105 may employ an N-type MOS transistor, which may be conducted in time in response to a voltage signal on the second anti-static wiring 102 upon the generating of high energy static electricity, so as to transfer and discharge the static electricity from the second anti-static wiring 102 to the first anti-static wiring 101 or the common electrode 104.

It should be noted that a position and a number of the first anti-static unit 103 and the second anti-static unit 105 can be set according to an actual size of the display panel, which is not particularly limited in this arrangement. Considering that a plurality of first anti-static units 103 and/or second anti-static units 105 may be disposed in a segmented manner to effectively reduce the effect of disconnection of the second anti-static wiring 102 on current transmission, however, it is preferable to provide at least two first anti-static units 103 and at least two second anti-static units 105 in this arrangement.

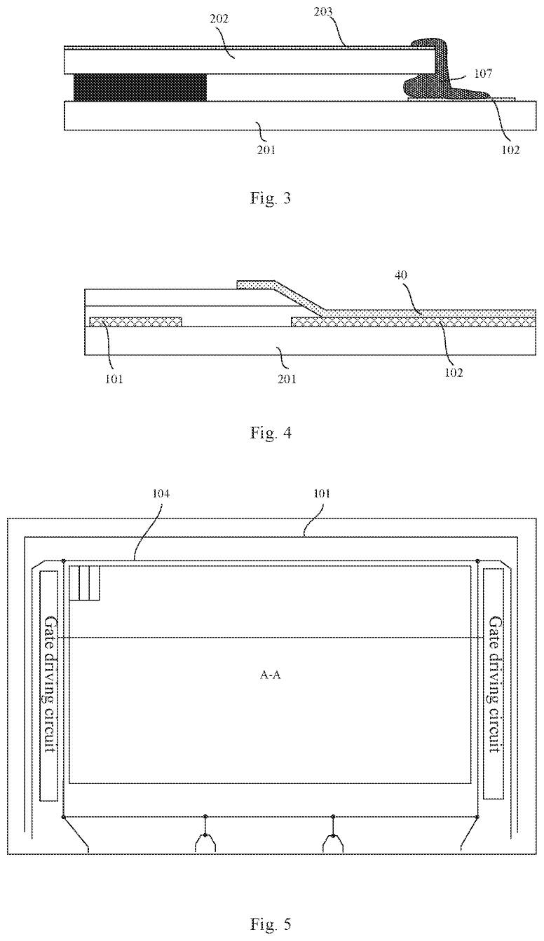

In this exemplary arrangement, as shown in FIGS. 2 and 3, the display panel may include an array substrate 201 and a color filter substrate 202 disposed opposite to each other to form a cell, and an electrostatic protection layer 203, such as an indium tin oxide (ITO) layer. The electrostatic protection layer 203 is disposed on a side of the color filter substrate 202 facing away from the array substrate 201, and the electrostatic protection layer 203 can be connected to a housing of the display device.

In this exemplary arrangement, referring to FIGS. 1 and 2, the second anti-static wiring 102 may be electrically connected to the electrostatic protection layer 203 through a first silver paste 106, and the first silver paste 106 may be evenly distributed on three sides of the display panel with no flexible circuit board being provided, and the first silver paste 106 is located at a side edge of the array substrate 201 and the color filter substrate 202 as shown in FIG. 2, a specific number of the first silver paste 106 may be set according to the actual size of the display panel.

In another exemplary arrangement, referring to FIGS. 1 and 3, the second anti-static wiring 102 may also be electrically connected to the electrostatic protection layer 203 through a second silver paste 107, which may be distributed on one side of the display panel on which a flexible circuit board is provided, and a specific number of the second silver paste 107 may be specified according to the actual size of the display panel.

In yet another exemplary arrangement, referring to FIGS. 1 to 3, the second anti-static wiring 102 may also be electrically connected to the electrostatic protection layer 203 through the first silver paste 106 and the second silver paste 107, respectively, as for a specific distribution manner and a specified number of the first silver paste 106 and the second silver paste 107, reference will be made to the above two implementations.

In this way, when an ESD experiment is conducted, an electrical arc occurring at the periphery of the display panel may be directly guided to the electrostatic protection layer 203 on an outer side of the color filter substrate 202 via the first silver paste 106 on one hand. On the other hand, the electrical arc may be guided to the second anti-static wiring 102 via the first silver paste 106, and then is directed to the electrostatic protection layer 203 on the outer side of the color filter substrate 202 by the second anti-static wiring 102 via the second silver paste 107. Since the electrostatic protection layer 203 is connected to the housing of the display device, the static electricity is discharged to perform electrostatic protection.

It should be noted that, as shown in FIG. 4, a metal oxide electrode 400 like an ITO electrode may be disposed between the second anti-static wiring 102 and the first silver paste 106 and/or between the second anti-static wiring 102 and the second silver paste 107, to provide an ohmic contact point for the silver pastes. In addition, since the second anti-static wiring 102 is usually formed by a gate metal layer, which is easily oxided, the metal oxide electrode may be provided to effectively prevent the oxidation of the second anti-static wiring 102.

This exemplary arrangement also provides a display device including the above-described display panel. The display device has an electrostatic protection function, and the display device may be any of a general display device, a narrow bezel display device, and a frameless display device, and is especially adapted for a frameless display device with an array substrate which is outwardly disposed.

Compared with the display device having an electrostatic protection function shown in FIG. 5, the display device provided by this exemplary arrangement includes a plurality of discharging paths, for example, the static electricity is discharged from the second anti-static wiring 102 to the flexible circuit board after passing through the first anti-static unit 103 and the first anti-static wiring 101, from the second anti-static wiring to the flexible circuit board after passing through the second anti-static unit 105 and the common electrode 104, from the first silver paste 106 to the housing after passing through the electrostatic protection layer 203 on the outer side of the color filter substrate 202, and from the first silver paste 106 to the housing after passing through the second anti-static wiring 102, the second silver paste 107, and the electrostatic protection layer 203 on the outer side of the color filter substrate 202. In this way, the plurality of discharging paths provided by the display device can significantly enhance the electrostatic discharge capability, thus preventing damage from being incurred in circuits or components due to ESD, and extending the service life of the display device.

In this exemplary arrangement, the display device may include, for example, any product or component having a display function, such as a mobile phone, a tablet computer, a television, a notebook computer, a digital photo frame, a navigator, etc., which is not particularly limited in the present disclosure.

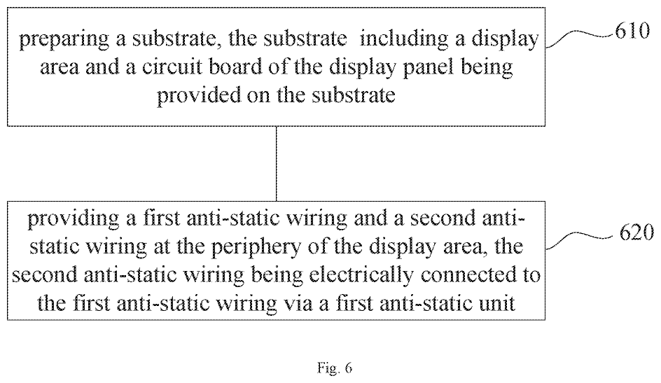

FIG. 6 schematically illustrates a flow chart of a method for manufacturing a display panel, according to an exemplary arrangement of the present disclosure. Referring to FIG. 6, the method for manufacturing a display panel according to an exemplary arrangement of the present disclosure may include the following blocks.

In block 610, a substrate is prepared. The substrate includes a display area and a circuit board of the display panel is provided on the substrate.

In block 620, a first anti-static wiring and a second anti-static wiring are provided at the periphery of the display area. The second anti-static wiring is electrically connected to the first anti-static wiring via a first anti-static unit. An orthographic projection of the second anti-static wiring on a display surface of the display panel is located at the periphery of an orthographic projection of the first anti-static wiring on the display surface of the display panel, and the first anti-static wiring and the second anti-static wiring are both electrically connected to the circuit board.

According to this arrangement, the method for manufacturing a display panel further includes forming a common electrode on the display area, which is disposed on the entire surface of the display area. The second anti-static wiring is also electrically connected to the common electrode via the second anti-static unit, and the common electrode is also electrically connected to the circuit board. In this arrangement, the first anti-static unit and the second anti-static unit are both switching transistors, and a control terminal of the first anti-static unit and a control terminal of the second anti-static unit are both connected to the second anti-static wiring.

According to this arrangement, the method for manufacturing a display panel further includes providing an insulating layer between the first anti-static wiring and the second anti-static wiring. In this arrangement, the first anti-static wiring and the second anti-static wiring are located in different layers in the display panel, and the insulating layer is formed across the different layers.

Other details of the method for manufacturing a display panel according to an exemplary arrangement of the present disclosure may be referred to detailed descriptions of the foregoing arrangements, which will not be described herein.

In the display panel and the display device provided by the exemplary arrangement of the present disclosure, the first anti-static wiring and the second anti-static wiring are both electrically connected to the circuit board, and are also connected to each other via the first anti-static unit. In this way, when a phenomenon of ESD occurs, a transient current is directed to the second anti-static wiring, at this time, the first anti-static unit is turned on by voltage of the second anti-static wiring to direct current on the second anti-static wiring to the first anti-static wiring, and the transient current generated by ESD can be directly directed to the circuit board by the second anti-static wiring on one hand, and also directed to the circuit board by the second anti-static wiring via the first anti-static unit and the first anti-static wiring on the other hand, thus enabling electrostatic discharge, to exert the effect of electrostatic protection of the display device.

Other arrangements of the present disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and arrangements be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof.

1. A display panel, comprising:
a first anti-static wiring and a second anti-static wiring disposed at a periphery of a display area, the second anti-static wiring being electrically connected to the first anti-static wiring via a first anti-static unit;
wherein an orthographic projection of the second anti-static wiring on a display surface of the display panel is located at a periphery of an orthographic projection of the first anti-static wiring on the display surface of the display panel, and the first anti-static wiring and the second anti-static wiring are both electrically connected to a circuit board of the display panel.

2. The display panel according to claim 1, wherein the display panel further comprises a common electrode, the second anti-static wiring is electrically connected to the common electrode via a second anti-static unit; and
wherein the common electrode is also electrically connected to the circuit board.

3. The display panel according to claim 2, wherein the common electrode is disposed on an entire surface in the display area.

4. The display panel according to claim 2, wherein the first anti-static unit and the second anti-static unit are both switching transistors, and a control terminal of the first anti-static unit and a control terminal of the second anti-static unit are both connected to the second anti-static wiring.

5. The display panel according to claim 4, wherein a number of the first anti-static unit and the second anti-static unit is two.

6. The display panel according to claim 1, wherein an insulating layer is disposed between the first anti-static wiring and the second anti-static wiring.

7. The display panel according to claim 1, wherein the display panel further comprises an array substrate and a color filter substrate disposed opposite to each other to form a cell, and an electrostatic protection layer disposed on a side of the color filter substrate facing away from the array substrate, the electrostatic protection layer being connected to a housing.

8. The display panel according to claim 7, wherein the second anti-static wiring is electrically connected to the electrostatic protection layer via a first silver paste, which is distributed on three sides of the display panel with no flexible circuit board being provided.

9. The display panel according to claim 8, wherein a metal oxide electrode is further disposed between the second anti-static wiring and the first silver paste.

10. The display panel according to claim 7, wherein the second anti-static wiring is electrically connected to the electrostatic protection layer via a second silver paste, which is distributed on one side of the display panel on which a flexible circuit board is provided.

11. The display panel according to claim 10, wherein a metal oxide electrode is further disposed between the second anti-static wiring and the second silver paste.

12. The display panel according to claim 1, wherein a connection point is provided on one side of the display panel, and the first anti-static wiring and the second anti-static wiring are electrically connected to the circuit board via the connection point, and the first anti-static wiring and the second anti-static wiring are surrounding at the periphery of the display area on three sides of the display panel, and not surrounding at the periphery of the display area on the one side of the display panel.

13. The display panel according to claim 6, wherein the first anti-static wiring and the second anti-static wiring are located in different layers of the display panel, and the insulating layer is provided across the different layers.

14. The display panel according to claim 1, wherein the display panel is a frameless display panel.

15. A display device, comprising the display panel according to claim 1.

16. A method for manufacturing a display panel, comprising:
preparing a substrate, which comprises a display area and is provided with a circuit board of the display panel;
disposing a first anti-static wiring and a second anti-static wiring at the periphery of the display area, the second anti-static wiring being electrically connected to the first anti-static wiring via a first anti-static unit,
wherein an orthographic projection of the second anti-static wiring on a display surface of the display panel is located at the periphery of an orthographic projection of the first anti-static wiring on the display surface of the display panel, and the first anti-static wiring and the second anti-static wiring are both electrically connected to the circuit board.

17. The method according to claim 16, further comprising:
forming a common electrode on the display area, the common electrode being disposed on an entire surface in the display area,
the second anti-static wiring is electrically connected to the common electrode via a second anti-static unit; and
wherein the common electrode is also electrically connected to the circuit board.

18. The method according to claim 17, wherein the first anti-static unit and the second anti-static unit are both switching transistors, and a control terminal of the first anti-static unit and a control terminal of the second anti-static unit are both connected to the second anti-static wiring.

19. The method according to claim 16, further comprising:
disposing an insulating layer between the first anti-static wiring and the second anti-static wiring.

20. The method according to claim 19, wherein the first anti-static wiring and the second anti-static wiring are located in different layers of the display panel, and the insulating layer is formed across the different layers.
